(19) United States
(12) Patent Application Publication
(10) Pub. No.: US 2010/0251353 A1
(43) Pub. Date: Sep. 30, 2010

(54) USER-AUTHORIZED INFORMATION CARD DELEGATION

(75) Inventor: Andrew A. Hodgkinson, Pleasant Grove, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 12/411,222

(22) Filed: Mar. 25, 2009

(51) Int. Cl. H04L 9/32; G06F 21/00

(52) U.S. Cl. 726/9; 235/380

(57) ABSTRACT

A system can include an authorization token provided by a user, the authorization token specifying user identification information to be made accessible by an information card host to a relying party, an information card stored at the information card host, and an identity token generated or requested by the information card host in response to a request for identity token from the relying party.

### CROSS-REFERENCE TO RELATED APPLICATIONS

This application is related to co-pending and commonly owned U.S. patent application Ser. No. 11/843,572, titled “PERFORMING A BUSINESS TRANSACTION WITHOUT DISCLOSING SENSITIVE IDENTITY INFORMATION TO A RELYING PARTY,” U.S. patent application Ser. No. 11/843,638, titled “POLICY-BASED AUDITING OF IDENTITY CREDENTIAL DISCLOSURE BY A SECURE TOKEN SERVICE,” U.S. patent application Ser. No. 11/843,640, titled “FRAMEWORK AND TECHNOLOGY TO ENABLE THE PORTABILITY OF INFORMATION CARDS,” U.S. patent application Ser. No. 11/843,608, titled “CHAINING INFORMATION CARD SELECTORS,” and U.S. patent application Ser. No. 11/843,591, titled “CREDENTIAL CATEGORIZATION,” all of which were filed on Aug. 22, 2007, and all of which claim the benefit of U.S. Provisional Patent Application Ser. Nos. 60/895,312, 60/895,316, and 60/895,325, which were filed on Mar. 16, 2007. All of the foregoing applications are fully incorporated by reference herein.

This application is also related to co-pending and commonly owned U.S. patent application Ser. No. 12/019,104, titled “PROCESSING HTML EXTENSIONS TO ENABLE SUPPORT OF INFORMATION CARDS BY A RELYING PARTY,” filed on Jan. 24, 2008, which claims the benefit of U.S. Provisional Patent Application Ser. No. 60/973,679, filed on Sep. 19, 2007; and is related to co-pending and commonly owned U.S. patent application Ser. No. 12/030,063, titled “INFO CARD SELECTOR RECEPTION OF IDENTITY PROVIDER BASED DATA PERTAINING TO INFO CARDS,” filed on Feb. 12, 2008; and is related to co-pending and commonly owned U.S. patent application Ser. No. 12/029,373, titled “VISUAL AND NON-VISUAL CUES FOR CONVEYING STATE OF INFORMATION CARDS, ELECTRONIC WALLETS, AND KEYRINGS,” filed on Feb. 11, 2008; and is related to co-pending and commonly owned U.S. patent application Ser. No. 12/054,774, titled “CLAIM CATEGORY HANDLING,” filed on Mar. 25, 2008; and is related to co-pending and commonly owned U.S. patent application Ser. No. 12/042,205, titled “PRIVATELY SHARING RELYING PARTY REPUTATION WITH INFORMATION CARD SELECTORS,” filed on Mar. 4, 2008; and is related to co-pending and commonly owned U.S. patent application Ser. No. 12/026,775, titled “METHODS FOR SETTING AND CHANGING THE USER CREDENTIAL IN INFORMATION CARDS,” filed on Feb. 6, 2008. All of the foregoing applications are fully incorporated by reference herein.

This application is also related to co-pending and commonly owned U.S. patent application Ser. No. 12/038,674, titled “SYSTEM AND METHOD FOR SECURE ACCOUNT RESET UTILIZING INFORMATION CARDS,” filed on Feb. 27, 2008; and is related to co-pending and commonly owned U.S. patent application Ser. No. 12/044,816, titled “SYSTEM AND METHOD FOR USING WORKFLOWS WITH INFORMATION CARDS,” filed on Mar. 7, 2008; and is related to co-pending and commonly owned U.S. patent application Ser. No. 12/108,805, titled “RESTRICTED USE INFORMATION CARDS,” filed on Apr. 24, 2008; and is related to co-pending and commonly owned U.S. patent application Ser. No. 12/112,772, titled “DYNAMIC INFORMATION CARD RENDERING,” filed on Apr. 30, 2008; and is related to co-pending and commonly owned U.S. patent application Ser. No. 12/054,137, titled “CARDSPACE HISTORY VALIDATOR,” filed on Mar. 24, 2008; and is related to co-pending and commonly owned U.S. patent application Ser. No. 12/111,874, titled “REMOTABLE INFORMATION CARDS,” filed on Apr. 29, 2008. All of the foregoing applications are fully incorporated by reference herein.

This application is also related to co-pending and commonly owned U.S. patent application Ser. No. 12/170,384, titled “NON-INTERACTIVE INFORMATION CARD TOKEN GENERATION,” filed on Jul. 9, 2008; and is related to co-pending and commonly owned U.S. patent application Ser. No. 12/184,155, titled “SITE-SPECIFIC CREDENTIAL GENERATION USING INFORMATION CARDS,” filed on Jul. 31, 2008; and is related to co-pending and commonly owned U.S. patent application Ser. No. 12/248,815, titled “TRUSTED RELYING PARTY PROXY FOR INFORMATION CARD TOKENS,” filed on Oct. 9, 2008; and is related to co-pending and commonly owned U.S. patent application Ser. No. 12/201,754, titled “SYSTEM AND METHOD FOR VIRTUAL INFORMATION CARDS,” filed on Aug. 29, 2008; and is related to co-pending and commonly owned U.S. patent application Ser. No. 12/352,465, titled “INFORMATION CARD OVERLAY,” filed on Jan. 12, 2009; and is related to co-pending and commonly owned U.S. patent application Ser. No. 12/360,313, titled “MULTIPLE PERSONA INFORMATION CARDS,” filed on Jan. 27, 2009. All of the foregoing applications are fully incorporated by reference herein.

### TECHNICAL FIELD

The disclosed technology pertains to using information cards, and more particularly to techniques pertaining to use of a user-directed authorization framework for information card delegation.

### BACKGROUND

When a user interacts with certain sites on the Internet such as service providers, which are also referred to as relying parties, the service provider often expects to know something about the user that is requesting the services of the provider. The typical approach for a service provider is to require the user to log into or authenticate to the service provider's computer system. But this approach, while satisfactory for the service provider, is less than ideal for the user.

For example, the user must remember a username and password for each service provider that expects such information. Given that different computer systems impose different requirements, along with the possibility that another user might have already chosen the same username, the user might not be able to use the same username/password combination for each such computer system. There is also the related problem that, if the user uses the same username/password combination on multiple computer systems, someone who hacks one such computer system would likely be able to access other such computer systems.

It is estimated that an average user has over 100 accounts on the Internet. For users, this is becoming an increasingly frustrating problem to deal with. Passwords and account names are too hard to remember. Second, the user typically has no control over how the service provider uses the information it stores. If the service provider uses the stored information in a way the user does not want, for example, the user has relatively little ability to prevent such abuse—and essentially no recourse after the fact.

In the past few years, the networking industry has developed the concept of information cards to tackle these problems. Information cards, which are also referred to as simply “cards,” have become a very familiar metaphor for users and the idea has been gaining rapid momentum. Information cards can allow users to not only manage their identity information but also control how the information is released. This provides users with greater convenience in organizing their multiple personae, their preferences, and their relationships with vendors and identity providers. In addition, interactions with on-line vendors have been greatly simplified.

A typical information card contains virtually any number of claims (e.g., certain pieces of information that each pertain to at least one aspect of the user's identity). Claims usually include, but are not limited to, the user's first name, last name, street address, city, state, zip code, email address, home phone number, office phone number, and mobile number.

There are currently two kinds of information cards: personal cards (or self-issued cards) and managed cards (or cards that are issued by an identity provider (IdP) or security token service (STS)). A personal card typically contains self-asserted identity information. In other words, the person issues the card and is the authority for the identity information it contains. In contrast, a managed card is generally issued by an identity provider, which provides the identity information and also asserts the validity of the provided information.

When a relying party requests certain information (e.g., identity information) from a user, a tool known as an identity selector or information card selector (“card selector”) can assist the user in selecting an appropriate information card or cards. For example, the card selector can present to the user one or more information cards that each satisfies a given security policy and also any particular claim requirements of the relying party. When a managed card is selected, the card selector can communicate with the identity provider to obtain a security token from the identity provider that contains the requested information.

While information card technologies are becoming more widespread in applications, there remain certain problems for which no adequate solutions currently exist. For example, consider a situation in which a third party (e.g., a bank) would like to perform an action with respect to a user (e.g., send an email message to a user). If the third party does not have the user's current contact information (e.g., email address), the action will most likely fail (e.g., the email message will “bounce”). In this type of situation, the third party would then need to bother the user for the user's current information so that the third party can perform the action. Because the user must be involved, this process can be annoying to the user, inefficient for the third party, and time-consuming for both the third party and the user. Furthermore, the user would assume a risk of sending the third party outdated, incomplete, or even incorrect information in response to the request for current information.

Thus, there remains a need for a way to address these and other problems associated with the prior art.

### SUMMARY

Implementations of the disclosed technology can advantageously allow a user to authorize an information card host to grant a relying party access to information stored within one or more of the user's information cards stored at the card host. Certain embodiments can include a mechanism that can effectively enable the relying party to retrieve identity information pertaining to the user from one of the user's information cards as stored by the information card host. Certain implementations can include the integration of OAuth into the authorization process.

Certain embodiments can include a client computer system, a relying party, and an information card host storing a user's information card. Using the client computer system (e.g., via an information card selector thereon), the user can provide an authorization token for the relying party. The authorization token can grant the relying party access to certain types of information pertaining to the user. In certain embodiments, the authorization token is sent to the relying party and stored by the relying party. Alternatively, the user can send the authorization token to the card host for storage or store it locally.

The relying party can send a request for an identity token to the card host. In certain embodiments, the relying party can include the authorization token with the request. The card host can then generate or request an identity token based on the authorization token and provide the identity token to the relying party. The identity token can provide some or all of the information requested by the relying party in accordance with the authorization token.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 illustrates an example of a sequence of communications between a client, a relying party, and an identity provider.

FIG. 2 illustrates an example of an information card system implemented within the client computer system of FIG. 1.

FIG. 3 illustrates a detailed example of one of the information cards stored at the client computer system of FIGS. 1 and 2.

FIG. 4 illustrates a first example of a sequence of communications between a client, a relying party, and an information card host in accordance with certain implementations of the disclosed technology.

FIG. 5 illustrates a first example of a method of information card delegation in accordance with certain user authorization framework implementations of the disclosed technology.

FIG. 6 illustrates a second example of a sequence of communications between a client, a relying party, and an information card host in accordance with certain implementations of the disclosed technology.

FIG. 7 illustrates a second example of a method of information card delegation in accordance with certain user authorization framework implementations of the disclosed technology.

### DETAILED DESCRIPTION

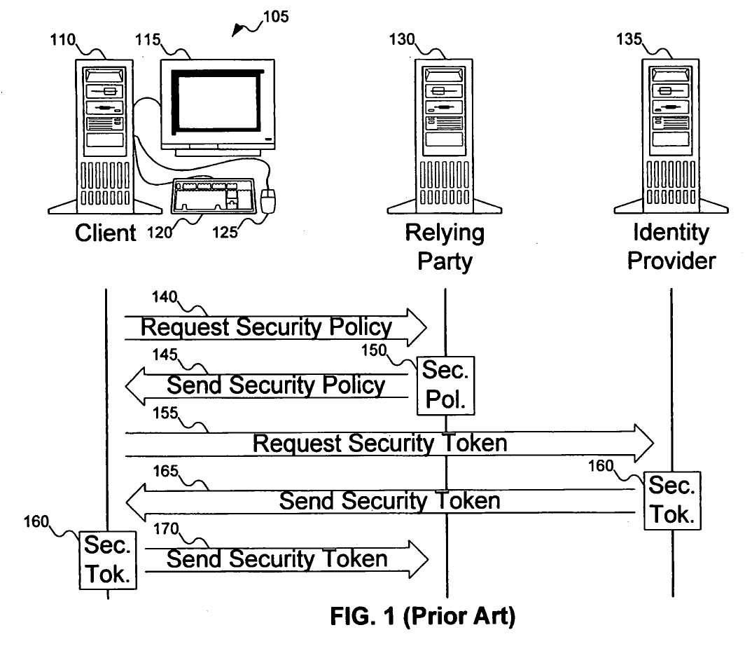

Before describing embodiments of the disclosed technology, it is important to understand the context of the disclosed technology. FIGS. 1-3 illustrate examples of typical information card-based systems and communications therein, information card systems at a client computer system, and information cards used with such systems, respectively.

### Exemplary Information Card-Based Systems and Communications Therein

FIG. 1 shows an example of a sequence of communications between a client computer system (“client”) 105, a relying party 130, and an identity provider 135. For simplicity, each of the parties (i.e., the client 105, the relying party 130, and the identity provider 135) may be referred to by their respective machines. Actions attributed to each party are taken by that particular party's machine, except where the context indicates that the actions are taken by the actual party itself.

In FIG. 1, the client computer system 105 is shown as including a computer 110, a monitor 115, a keyboard 120, and a mouse 125. One having ordinary skill in the art will recognize that various other components can be used in connection with the client computer system 105, such as a printer and/or other input/output devices, for example. In addition, FIG. 1 does not show some of the conventional internal components of the client computer system 105, such as a central processing unit, memory, storage, etc.

Although FIG. 1 shows the client computer system 105 as a conventional desktop computer system, one having ordinary skill in the art will recognize that the client computer system 105 can be any type of machine or computing device capable of providing the services attributed herein to the computer system 105, including, but not limited to, a laptop computer, a personal digital assistant (PDA), or a cellular telephone, for example.

One having ordinary skill in the art will recognize that the computer system 105 can readily interact with other computer systems, such as the relying party 130 and the identity provider 135, either directly or over a network of virtually any type (such as a cable network, a wireless network, and the like).

The relying party 130 is typically a machine managed by a third party that relies in some way on the identity of the user of the client computer system 105. The operator of the relying party 130 can generally be any type of relying party. For example, the operator of the relying party 130 can be a merchant running a business on a website or a system administrator managing customer accounts for a bank. Alternatively, the operator of the relying party 130 can be an entity that offers assistance on some matter to registered parties. The relying party 130 is so named because it relies on establishing some identifying information about the user. For purposes of the present application, the relying party 130 can refer to an application residing on and/or running on the client computer system 105 itself.

The identity provider 135 is typically managed by a party that is responsible for providing identity information (or other such information) about the user for consumption by the relying party 130. Depending on the type of information that the identity provider 135 stores for a user, a single user might store identifying information with any number of different identity providers 135, any of which might be able to satisfy the request of the relying party 130. For example, the identity provider 135 might be a governmental agency responsible for storing information generated by the government, such as a driver's license number or a social security number. Alternatively, the identity provider 135 might be a third party that is in the business of managing identity information on behalf of a wide variety of users.

Conventional methodology of releasing identity information can be found in a number of sources, such as a document published by Microsoft entitled “Introducing Windows CardSpace,” which can be found on the World Wide Web at http://msdn2.microsoft.com/en-us/library/aa480189.aspx and is hereby incorporated by reference. To summarize the operation of Windows CardSpace, when a user wants to access some data from the relying party 130, the client computer system 105 can request the security policy of the relying party 130, as shown in a first communication 140, which is returned in a second communication 145 as a security policy 150. The security policy 150 is typically a summary of the information the relying party 130 needs, how the information should be formatted, and so on.

Once the computer system 105 has the security policy 150, the client computer system 105 can identify which information cards will satisfy the security policy 150. Different security policies might result in different information cards being usable. For example, if the relying party 130 simply needs a username and password combination from the user, the information cards that will satisfy this security policy will typically be different from the information cards that satisfy a security policy requesting the user's full name, mailing address, and social security number. The user can then select an information card that satisfies the security policy 150.

An information card selector on the computer system 105 can be used by the user to select one or more appropriate information cards. The card selector may present the user with a list or graphical display of all available information cards. Information cards that satisfy the security policy may be highlighted in some way to distinguish them from the remaining cards. Alternatively, the card selector may display only the information cards that will satisfy the security policy. The card selector may provide a means for the user to select the desired information card by way of a mouse click or a touch on a touch screen, for example.

Once the user has selected at least one acceptable information card, the client computer system 105 can use the selected information card to transmit a request for a security token (RST) from the identity provider 135, as shown in a third communication 155. This request can identify the data to be included in the security token, the credential that identifies the user, and other data that the identity provider needs in order to generate the security token. The identity provider 135 can then return a security token 160, as shown in a fourth communication 165.

The security token 160 can include any number of claims (e.g., pieces of information) that typically include data that the user wants to release to the relying party, such as the user's identity information. The security token 160 is usually encrypted in some manner, and perhaps signed and/or time-stamped by the identity provider 135 so that the relying party 130 can be certain that the security token originated with the identity provider 135, as opposed to being spoofed by someone intent on defrauding the relying party 130. The computer system 105 can then forward the security token 160 to the relying party 130, as shown in a communication 170.

In addition, the selected information card can be a self-issued information card, which is also referred to as a personal card. A self-issued information card typically refers to an information card that is issued not by an identity provider but by the computer system 105 itself. In that case, the identity provider 135 effectively becomes part of the computer system 105.

In this model, a person skilled in the art will recognize that because all of the pertinent information flows through the computer system 105, the user has a measure of control over the release of the user's identity information. The relying party 130 only receives the information the user wants the relying party 130 to have, and generally does not store that information on behalf of the user.

### Exemplary Information Card Systems at a Client Computer System

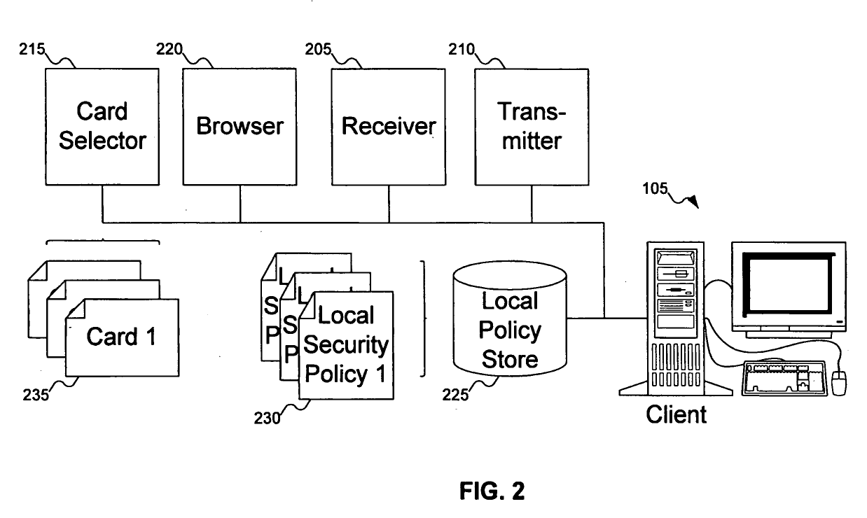

FIG. 2 shows an example of an information card system situated at the client computer system 105 of FIG. 1. In the example, the client computer system 105 includes a receiver 205, a transmitter 210, a card selector 215, and a browser 220. The receiver 205 is generally responsible for receiving data transmitted to the computer system 105, while the transmitter 210 is usually responsible for transmitting information from the client computer system 105. The receiver 205 and the transmitter 210 may facilitate communications between the client computer system 105, the relying party 130, and the identity provider 135, for example.

The card selector 215 is typically responsible for enabling a user to select an information card that satisfies a particular security policy. The card selector can present the user with either a single information card 235 or virtually any number of information cards from which the user can select a particular card. The card selector 215 is also typically responsible for enabling a user to obtain managed cards from identity providers and to install the managed cards on the computer system 105. Certain implementations of the disclosed technology can include a mapping functionality between the card selector and the identity provider.

The browser 220 can allow the user to interact with web pages on a network, such as web pages created by the identity provider 135. The user may use the browser 220 to obtain a managed card by, for example, visiting a web page created by the identity provider 135 and filling out a web-based form.

The computer system 105 can also include a local policy store 225, which can store local security policies such as local security policy 230. In the example, the local security policy 230 is a local security policy defining how certain information cards can be defined and used.

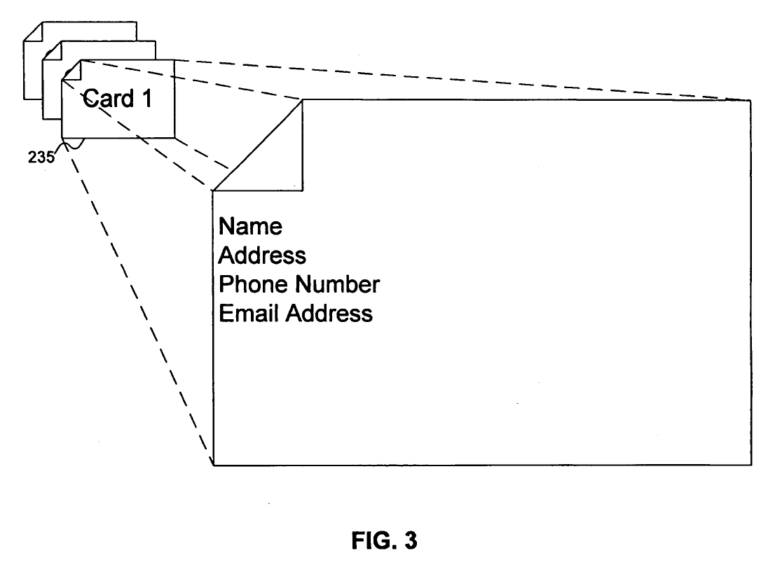

An example of an information card is illustrated in FIG. 3, which shows the information card 235 of FIG. 2 in greater detail. As discussed above, a typical information card contains virtually any number of claims that include, but are not limited to, the user's name, mailing and/or residence address, email address, phone number(s), and any private personal identifier (PPID). A typical claim consists of a claim type or category such as name, date of birth, gender, etc., and a claim identifier (e.g., user-specific data for the pertinent claim type). In the example, the information card 235 contains four claims having the following claim types: name, address, phone number, and email address.

If the information card 235 is a managed card (e.g., managed by the identity provider 135 of FIG. 1), the information represented by the information card 235 would not be stored on the client computer system 105; rather, the information would be stored by the identity provider 135 itself. Thus, the information displayed on the information card 235 would not be the actual information stored at the client computer system 105, but rather a mere indicator of what kind of information is included in the information card 235.

### Exemplary Frameworks for User-Authorized Information Card Delegation

As discussed above, information cards can advantageously provide a user with easy-to-use and secure methods of authentication and disclosure of details pertaining to the user's identity, such as email address and date-of-birth, for example. One drawback of current information card-based systems, however, is that identity transactions are initiated by the user. This typically occurs when a user visits a website and either uses an information card to authenticate and/or to complete a purchase. In such a scenario, the user generally initiates the interaction with the relying party and the identity transaction is completed in real time.

Another significant issue associated with prior information card-based systems is related to the synchronization of information cards across multiple clients. To address this issued, hosted card services (“card hosts”) are quickly becoming a preferred way of managing a user's “wallet” of information cards. That is, rather than storing multiple information cards on the local drive of a client computer system such as a desktop computer or an iPhone, for example, the information cards are stored in the cloud (e.g., a card service or file service on the Internet or other network), which effectively eliminates the need for a user to constantly import and export his or her information cards from each client.

A hosted card service can provide more than just information card storage-related services, however. Since most mobile devices lack the processing power that is usually required to derive the keys needed to make information card-based security token requests, the task of building a security token request can be offloaded to the hosted card service. Thus, a basic information card client can simply provide an interface (such as a graphical user interface or GUI, for example) to the hosted service as well as a conduit for passing a security token back to the requesting application (such as a web browser). This arrangement desirably results in a significantly improved experience for mobile users.

The implementation of a service that can both manage information cards and support all of the logic needed to request security tokens as described above, however, does present a notable issue. Consider an example in which a bank, acting as a relying party, sends out an email message to inform its customers (users) about a special rate on auto loans. However, because several customers have changed their email addresses since the last time they updated their profiles at the bank, those customers will most likely not receive the email message from the bank. In fact, the provider of each changed or expired email address will likely “bounce” the message back to the bank's server. In order to deliver the content of the message, the bank must either contact those customers through some alternate (and likely more expensive) channel or wait until the customers visit the bank's web site again and hopefully update their email address so that the bank can obtain the users' updated email addresses.

Implementations of the disclosed technology can advantageously allow a relying party (e.g., a bank) to request up-to-date information (e.g., email address, phone number, etc.) of a certain user or group of users (e.g., customers) without requiring direct interaction with any of the users at the time of the request. In certain embodiments, a customer user can grant permission to a third party (e.g., a bank) to access and use a particular information card stored at the user's hosted card service. The card can be a standard information card having a set of supported claims and token types. In the example, the bank can simply contact the hosted card service, present its authorization token to access the information card, and request an identity token based on the supported claims and other information in the card. Using the information returned in the token, the relying party can then complete the transaction (e.g., a bank could update its database and re-send the email to the customers).

While the sequence of steps described above are desirably performed with the customer's permission, the steps would not require any human intervention (at least, not beyond the one-time authorization by the user). Thus, such implementations are still considered user-centric (e.g., the user is in control of disclosure of their personal information to the relying party). Should the customer user decide at some future point that he or she no longer wants the bank to have access to the user's information card, however, he or she could simple revoke the authorization.

Thus, implementations of the disclosed technology can advantageously allow users to better manage their identities using the familiar information card metaphor, while leveraging authorization functionality to allow trusted third parties (e.g., relying parties) to access a subset of the user's identity data whenever the data is needed by the relying party (subject to any constraints of the authorization).

### Exemplary Implementations of the Disclosed Technology Involving Storage of an Authorization Token at a Relying Party

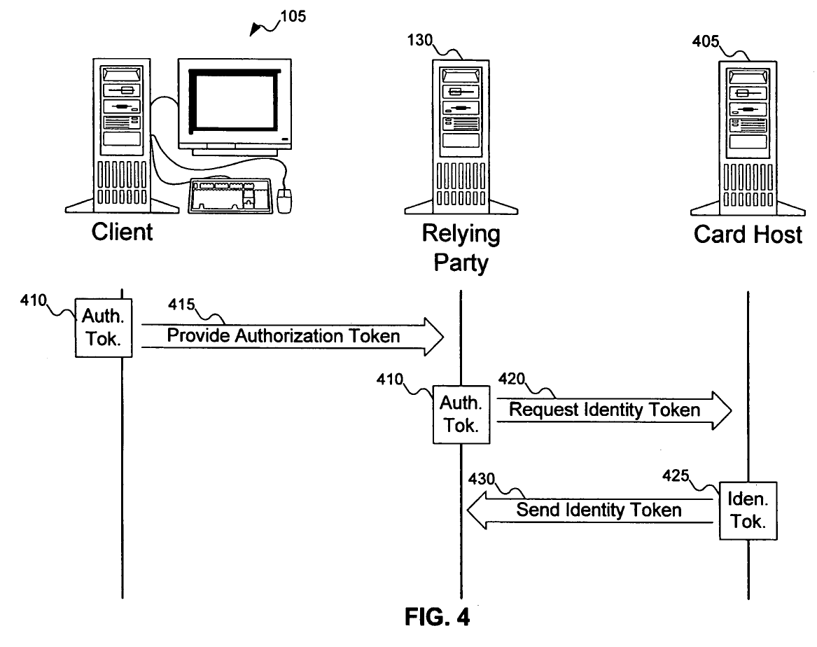

FIG. 4 illustrates a first example of a sequence of communications between the client computer system 105, the relying party 130 (e.g., a third party such as a bank), and an information card host 405 in accordance with certain implementations of the disclosed technology. In certain embodiments, the card host 405 is an information card hosting service at a location remote from the client computer system 105. Alternatively, the card host 405 can either be an identity provider itself or work in connection with one or more identity providers.

In the example, a user provides an authorization token 410 at the client computer system 105. For example, the user can specifically request the authorization token 410 (e.g., via a card selector at the client 105) for the purpose of granting the relying party 130 access to a particular information card (not shown) stored at the card host 405. It should be noted that the user can first obtain the particular information card in a number of ways. For example, the user can establish a special information card (e.g., specific to the relying party 130) from an identity provider.

The authorization token 410 can generally be thought of as a representation of a trust relationship that is created between the user and the relying party 130. That is, the authorization token 410 effectively provides a third party (e.g., the relying party) with restricted access to a user's protected resource (e.g., the user's information card stored at the card host) on the user's behalf.

Once generated, the authorization token 410 can be provided to the relying party 130, as shown by a first communication 415. The relying party 130 can store the authorization token 410 until needed, for example, at which point the relying party 130 can transmit the authorization token 410 and a request for identity token to the card host 405, as shown by a second communication 420.

After the card host 405 receives the authorization token 410 and request for an identity token, the card host 405 can first confirm that the authorization token 410 is legitimate and valid (e.g., it has not yet expired or been revoked). Once the card host 405 confirms the authorization token 410 and request for identity token, the card host 405 can retrieve the information from the stored information card in accordance with the restrictions set forth by the authorization token 410. In other words, the authorization and granting of rights are considered to both happen at the location of the protected resource (e.g., the user's information card stored at the card host 405).

The card host 405 can generate or request an identity token 425 based on the information retrieved from the stored information card. For example, if the authorization token 410 specifies that the user has granted the relying party 130 access to the user's email address, the card host 405 can retrieve the user's email address information from the stored information card and generate the identity token 425 based on the user's email address.

The card host 405 can then forward the identity token 425 to the relying party 130, as shown by a third communication 430, at which point the relying party 130 can make use of the information within the identity token 425 (e.g., to send an email message to the user's email address).

The authorization token 410 can specify what information (e.g., claims) in the information card can be accessed by the relying party 130. In certain embodiments, the information card is generated specifically for interactions with the relying party 130, in which case the authorization token 410 can specify that the user grants the relying party 130 full access to the information stored within the information card.

The authorization token 410 can include a virtually unlimited number of restrictions. For example, the user can specify in the authorization token 410 that the relying party 130 can only use the authorization token 410 on certain days and/or at certain times of the day. The user could also decide to not set an expiration date so that the relying party 130 can use the authorization token 410 indefinitely (or until the authorization token 410 is revoked).

A user can also use the authorization token 410 to set limits on the access to be granted to the relying party 130. For example, the user may establish a certain level of granularity by specifying that the relying party can only access certain types of information (e.g., email address or phone number) in the information card stored at the card host 405.

Alternatively, such as in situations where the user wishes to use the same information card for multiple relying parties (but not disclose the same information to each relying party), the authorization token 410 can be tailored specifically to the relying party. Thus, if the user makes a single change to the stored information card (e.g., the user updates his or her email address), the updated information would be advantageously propagated to each relying party for which the user has granted access to the information.

Thus, once the user updates his or her information card, the card host 405 will provide the relying party 130 with the updated information (e.g., via the identity token 425) the next time the relying party 130 sends a request for an identity token to the card host 405, assuming the updated information is of an information type to which the relying party 130 has been granted access, of course.

In certain embodiments, the relying party 130 can store the authorization token 410 until the authorization token 410 expires or is revoked (e.g., by the user), or until the relying party 130 abuses the authorization token 410 (such as by requesting an identity token based on the authorization token 410 too often or at times expressly restricted by the user, for example).

The card host 405 is said to operate as an enforcer in that it enforces the user's wishes as codified in the authorization token 410. For example, if the relying party 130 requests information to which it has not been granted access by the user, the card host 405 can prevent dissemination of the requested information and inform the relying party 130 of the denial of information.

In situations where only some of the information requested by the relying party is restricted, the card host 405 can either provide the requested information to which the relying party 130 has been granted access or deny the relying party 130 any of the requested information. The card host 405 can either send a message to the relying party 130 informing it of the partial or full denial of information or send no such communication. In addition, the card host 405 can alert the user of a denial of information for a relying party (e.g., after each incident or only after a certain number of total incidents for a particular relying party or overall). Any or all of the options described in this paragraph, as well as other options, can be captured in a policy (e.g., created by the user) to be consulted by the card host 405 when handling each request for an identity token, for example.

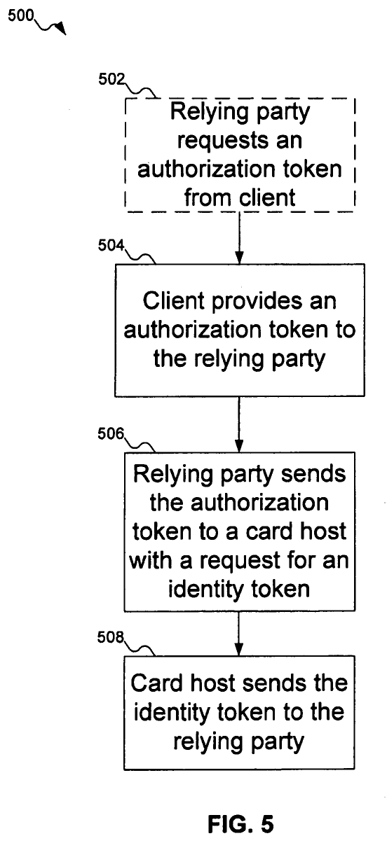

FIG. 5 illustrates a first example of a method 500 of information card delegation in accordance with certain user authorization framework implementations of the disclosed technology, such as the system illustrated in FIG. 4. At 502, a relying party (third party) requests an authorization token from a user (e.g., via the user's client computer system). The dashed lines indicate that step 502 is optional. For example, the user can proactively provide an authorization token to the relying party before any such request is generated, let alone sent by the relying party.

At 504, the user provides the requested authorization token to the relying party (e.g., via a card selector at the user's client computer system). The authorization token can be pre-determined (e.g., a default authorization token that the user provides to every third party) or generated specifically in response to the request from the relying party. Thus, in certain embodiments, the user can advantageously generate multiple authorization tokens, one for each relying party.

At 506, the relying party sends the authorization token, along with a request for an identity token, to the user's designated card host. Responsive to the request, the card host can provide (e.g., generate or request) an identity token for the relying party. In certain embodiments, the identity token may already exist at the card host, such as in situations where the user has only one authorization token but uses it for each of a number of relying parties.

In certain embodiments, the relying party can request metadata about the information card stored at the user's card host. A policy (e.g., established by the user) can dictate what, if any, metadata (e.g., identity attributes supported by the card) the relying party is authorized to retrieve. For example, if the relying party does not have an email address or mailing address for the user, the relying party can determine whether the information card contains information pertaining to the user's email address information or mailing address information.

At 508, the card host sends the identity token to the relying party. In certain embodiments, the card host can keep a copy of the identity token at the card host (e.g., in case the same relying party sends a request for an identity token in the future using the same authorization token).

In certain embodiments, the user can update the information card stored at the card host. For example, the user can inform the identity provider that originally issued the card that he or she wishes to add a particular attribute to the information card. The identity provider could then issue a new card to be sent to the card host as a replacement for the stored card. By updating its database with the new information, the identity provider would then be said to fully support the newly added attribute in the stored information card.

### Exemplary Implementations of the Disclosed Technology Involving Storage of an Authorization Token at an Information Card Host

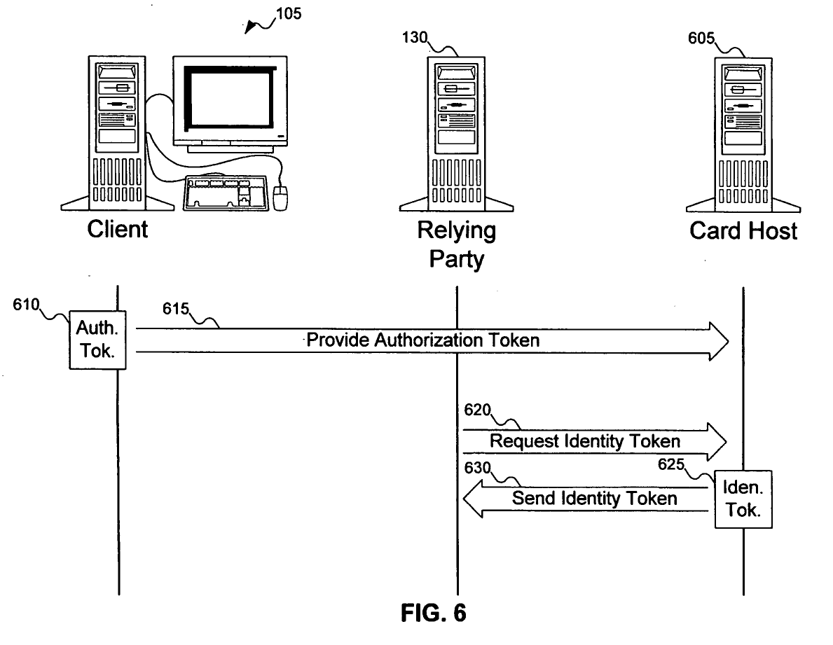

FIG. 6 illustrates a second example of a sequence of communications between the client computer system 105, the relying party 130 (e.g., a third party), and an information card host 605 in accordance with certain implementations of the disclosed technology. In the example, a user provides an authorization token 610 at the client computer system 105. For example, the user can specifically request the authorization token 610 (e.g., via a card selector at the client 105) for the purpose of granting the relying party 130 access to a particular information card (not shown) stored at the card host 605.

Once generated, the authorization token 610 can be provided directly to the card host 605, as shown by a first communication 615. The card host 605 can store the authorization token 610 until needed (e.g., for generating an identity token in response to a request for the identity token from the relying party 130).

In the example, the relying party 130 sends a request for an identity token to the card host 605, as shown by a second communication 620. Once the card host 605 receives the request, the card host 605 can first confirm that there is a legitimate and valid authorization token stored at the card host 605 for the relying party 130. Once the card host 605 confirms this, the card host 605 can then proceed to retrieve the information from the stored information card in accordance with the restrictions set forth by the authorization token 610.

The card host 605 can generate or request an identity token 625 based on the information retrieved from the stored information card. The card host 605 can then forward the identity token 625 to the relying party 130, as shown by a third communication 630. Once the relying party receives the identity token 625 from the card host 605, the relying party 130 can then make use of the user's information that is contained within the identity token 425 returned to the relying party 130.

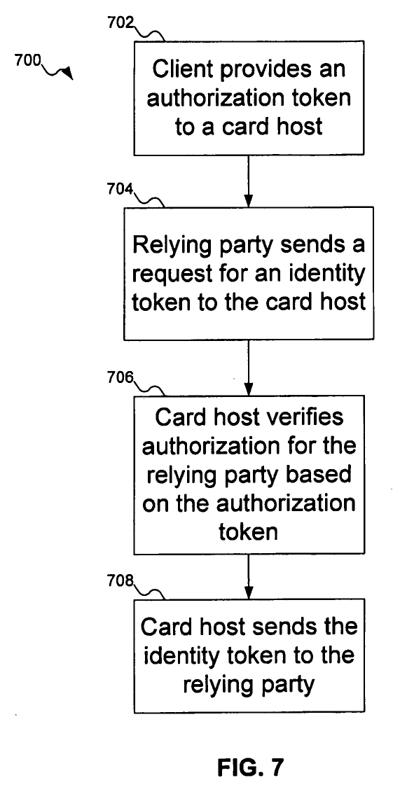

FIG. 7 illustrates a second example of a method 700 of information card delegation in accordance with certain user authorization framework implementations of the disclosed technology. At 702, a user (e.g., via a client computer system) provides an authorization token to a card host. In certain embodiments, the user provides the authorization token in response to a request for such a token by a third party or by a card host (e.g., in response to a request made from the third party to the card host). Alternatively, the user can proactively provide the authorization token (e.g., when establishing an account at the third party).

At 704, the third party (e.g., relying party 130) sends a request for an identity token to the card host. For example, the card host can be an information card hosting service at which the user stores an information card for the purpose of providing certain types of information to one or more third parties based on authorizations as specified in the authorization token provided by the user at 702.

At 706, the card host verifies the authorization for the relying party based on the authorization token. For example, the relying party may need to authenticate to the card host. Also, the card host may perform a check to determine whether the authorization token has expired, has been revoked (e.g., by the user directly or indirectly), or has terminated for some other reason.

In addition, the authorization token may set forth specific conditions that need to be met by the relying party in order for the card host to continue. For example, the authorization may set forth the user's desire that the relying party not access the user's information via the information card at the card host between the hours of midnight and five a.m. (e.g., in an attempt by the user to curb late-night communications from the relying party).

At 708, the card host sends the requested identity token to the relying party. In certain embodiments, the card host first provides (e.g., generates or requests) the identity token. Alternatively, there may be a default identity token or previously generated identity token that provides the requested information in accordance with the authorization token.

### Exemplary Implementations Involving Multiple Relying Parties

Consider an example in which a user is a customer of three different banks: Bank A, Bank B, and Bank C. The user may have an information card stored at a card host and wish to use the same information card for each bank. However, the user may also wish that Bank A's access be restricted to the user's email address only, that Bank B's access be restricted to the user's phone number only, and that Bank C's access be restricted to the user's mailing address only. The user can generate a first authorization token for Bank A, a second authorization token for Bank B, and a third authorization token for Bank C, where each token specifies the corresponding restriction desired by the user as discussed above.

In the example, the user sends the first authorization token directly to Bank A (e.g., via a card selector). Bank A would then store the first authorization token until needed. At that time, Bank A could send the first authorization token to the card host along with a request for an identity token. The card host could then retrieve information from the user's information card stored at the card host as specified by the first authorization token.

In the example, the first authorization token specifies that the user has granted Bank A access to only the user's email address information. Thus, the card host could generate an identity token based on the user's email address information as stored in the information card and return the identity token to Bank A, which could then make use of the information in the identity token (e.g., by sending an email message to the user's email address as indicated in the identity token).

In the example, the user sends the second authorization token to the card host (e.g., via a card selector). Once Bank B needs the user's phone number (e.g., to call the user about his or her account at the bank), Bank B can send a request for an identity token to the card host. The card host would first check to see if Bank B has an authorization token and, if so, retrieve it. After retrieving the second authorization token, Bank B could then retrieve information from the user's information card stored at the card host as specified by the second authorization token.

In the example, the second authorization token specifies that the user has granted Bank B access to only the user's phone information. Thus, the card host could generate or request an identity token based on the user's phone information as stored in the information card and return the identity token to Bank B, which could then make use of the information in the identity token (e.g., by making the call to the user using the user's phone number as provided in the identity token).

In the example, the user stores the third authorization token locally (e.g., at the user's client computer system). Once Bank C needs the user's mailing address (e.g., to mail a prospectus), Bank C can send a request for an identity token to the client computer system. The client computer system can provide the third authorization token to Bank C (e.g., via a card selector). Bank C could send the third authorization token to the card host along with a request for an identity token. The card host could then retrieve information from the user's information card stored at the card host as specified by the third authorization token.

In the example, the third authorization token specifies that the user has granted Bank C access to only the user's mailing address information. Thus, the card host could generate or request an identity token based on the user's mailing address information as stored in the information card and return the identity token to Bank C, which could then make use of the information in the identity token (e.g., by mailing the prospectus to the user's mailing address as provided in the identity token).

### Exemplary Implementations Using OAuth

OAuth is an open protocol that can be used to allow secure API authorization from desktop and web applications. OAuth defines an authorization framework that, for purposes of illustration, can be analogized to the use of a car's valet key. By giving the car's valet key to an attendant, the owner of the car grants the valet limited access to the car via the valet key so that the car can be parked by the attendant. The valet key can be used to open the driver-side door of the car and start the engine, but it will not allow access to the glove compartment or trunk. Once the attendant no longer requires access to the car, the owner of the car can revoke the authorization by simply taking the key back from the attendant.

OAuth can enable a user to grant restricted access to resources on the Internet that the user controls, such as documents and media files, for example. Rather than providing credentials to a third-party (e.g., a photo printing service) so that the third party can access the user's resources, the user can instead authorize access and specify the rights associated with that access, such as read, update, and delete, for example. The user can also specify an expiration time, a number of times that the resource can be accessed, and other such authorization constraints.

Authorization tokens can be used to provide authorization in implementations using OAuth. Such arrangements can advantageously enable owners to maintain complete control over access to their resources with respect to the pertinent third party. The arrangements can also serve to mitigate the risk of an unscrupulous third party using an owner's credentials for unintended purposes because the credentials are never provided to the third party.

General Description of a Suitable Machine in which Embodiments of the Disclosed Technology can be Implemented

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, and the like.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like. The machine can be controlled, at least in part, by input from conventional input devices (e.g., keyboards and mice), as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, physical storage media.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A system, comprising:
an authorization token provided by a user, wherein the authorization token comprises relying party access information specifying user identification information to be made accessible by an information card host to a relying party;
an information card stored at the information card host, wherein the information card comprises the user identification information; and
an identity token provided by the information card host in response to a request for identity token from the relying party, wherein the identity token is based at least in part on the authorization token, and wherein the identity token comprises the user identification information.

2. The system of claim 1, wherein the user identification information comprises at least one of an email address, a phone number, a date of birth, and a mailing address.

3. The system of claim 1, wherein the authorization token comprises an OAuth token.

9. The system of claim 1, wherein the relying party access information comprises at least one user-specified restriction, wherein the at least one user-specified restriction comprises an authorization token expiration date.

10. The system of claim 1, wherein the authorization token is generated specifically for the relying party only.

11. The system of claim 1, wherein the authorization token is generated for the relying party and at least one other relying party.

12. The system of claim 1, wherein the authorization token is stored at the relying party.

13. The system of claim 1, wherein the authorization token is stored at the information card host.

14. The system of claim 1, wherein the identity token is requested by the information card host.

15. A computer-implemented method, comprising:
storing an information card at an information card host, wherein the information card comprises identity information pertaining to a user;
receiving an authorization token for a relying party at the information card host, wherein the authorization token specifies a granting of access privileges to at least a portion of the identity information by the user;
receiving from the relying party a request for an identity token at the information card host;
generating an identity token at the information card host, wherein the identity token is based on the authorization token, and wherein the identity token comprises the identity information of the user; and
transmitting the identity token to the relying party.

16. The computer-implemented method of claim 15, further comprising storing the authorization token at the information card host.

17. The computer-implemented method of claim 15, further comprising storing the authorization token at the relying party.

18. The computer-implemented method of claim 17, wherein the steps of receiving the authorization token and receiving the request are performed concurrently with each other.

19. The computer-implemented method of claim 15, further comprising performing an authentication of the authorization token.

20. The computer-implemented method of claim 15, further comprising omitting identity information to which no granting of access privileges is specified the authorization token.

21. The computer-implemented method of claim 20, further comprising notifying the relying party of the omitting.

22. The computer-implemented method of claim 15, further comprising updating the information card using an identity provider.

23. The computer-implemented method of claim 15, further comprising revoking the authorization token.

24. The computer-implemented method of claim 15, wherein the identity token comprises metadata pertaining to the information card.

25. One or more tangible, computer-readable media storing computer-executable instructions that, when executed by a processor, perform the computer-implemented method of claim 15.
